(19) United States
(12) Patent Application Publication
(10) Pub. No.: US 2022/0368803 A1
(43) Pub. Date: Nov. 17, 2022

(54) SYSTEM AND METHOD FOR IDENTIFYING NETWORK EQUIPMENT FROM A REMOTE LOCATION

(71) Applicant: PPC BROADBAND, INC., East Syracuse, NY (US)

(72) Inventor: David A. Barany, Syracuse, NY (US)

(21) Appl. No.: 17/742,834

(22) Filed: May 12, 2022

Related U.S. Application Data
(60) Provisional application No. 63/187,838, filed on May 12, 2021.

(51) Int. Cl. H04M 7/00

(52) U.S. Cl. CPC H04M 7/0024

(57) ABSTRACT

A system for identifying a subscriber device may include a customer premises device and a DOCSIS device. The DOCSIS device may be connected to the cable network. The customer premises device may be configured to generate a low power radio frequency carrier signal having a predetermined frequency and a predetermined modulation that correlates to a type of customer premises device. The customer premises device may be configured to inject the low power radio frequency carrier signal into a signal wherein the signal is received by the DOCSIS device. The DOCSIS device may identify the customer premises device based on the predetermined frequency and the predetermined modulation by comparing the frequency measurement and the modulation measurement to a prestored frequency data and a prestored modulation data that correlates to a plurality of types of the customer premises device.

### CROSS REFERENCE TO RELATED APPLICATION

This application claims priority to U.S. Provisional Patent Application No. 63/187,838 filed May 12, 2021, the disclosure of which is incorporated herein by reference in its entirety.

### TECHNICAL FIELD

The present disclosure generally relates to data-over-cable or cable network system, and more particularly to a system and method for identifying network equipment from a remote location.

### BACKGROUND

Broadband service providers for distributed computing network services such as cable television (CATV) service typically require the end user, e.g., the home or business CATV subscriber, to employ a router, switch, or other customer premises equipment (CPE) to terminate the CATV connection at the residence or business location. The router or other CPE serves to terminate the Asynchronous Transfer Mode (ATM) connection, and generally utilizes point-to-point-over-Ethernet (PPPoE) enabled software to complete the user authentication process.

Most service providers use a 5-1002 MHz RF spectrum. However, some providers are considering to expand to a 5-1218 MHz frequency spectrum to add more data. This expansion of the frequency spectrum will exceed 1002 MhZ could present issues for older CPE equipment (ex: amplifiers) which are configured to handle at most a signal at 1002 MHz. However, in general, when a subscriber encounters a problem with their connection, the service provider has no way to automatically determine the specific make and/or model of a particular CPE device being utilized by the CATV subscriber. In this situation, telephone inquiries to the subscriber are made to attempt to discover what type of equipment is being utilized at the CPE location, or a service technician is dispatched to “eyeball” the equipment when the customer does not know what type of CPE device is at their location. Consider a typical case of tens of thousands (or even millions, in some cases) of CATV subscribers and their respective CPE devices, and the support problems presented to the CATV service provider become evident.

Moreover, when a service provider wishes to upgrade CATV transport services in their service area(s), e.g., the provision of Point to Point Protocol Termination and Aggregation (PTA), it may be difficult to cost-effectively deploy the new service plan if the service provider does not know what types of CPE devices are currently deployed. For example, if a new transport service is scheduled for deployment in a specific geographic region, but it is determined that a large number of CPE devices may not support the new service, delays in deployment result. Such delays lead to increased provider costs, which are typically passed along to the subscribers, resulting in higher rates.

### SUMMARY

The present disclosure relates to a method and system for identifying a subscriber device at a subscriber site from a remote location. In a first example embodiment of the system, the system may include a customer premises device and a DOCSIS device. The customer premises device may be disposed at a customer site and may be configured to be connected to a cable network. The DOCSIS device may be connected to the cable network. The customer premises device may be configured to generate a low power radio frequency carrier signal having a predetermined frequency and a predetermined modulation that correlates to a type of customer premises device. The customer premises device may be configured to inject the low power radio frequency carrier signal into a signal wherein the signal is received by the DOCSIS device.

In this embodiment, DOCSIS device may be configured to generate a measurement data set from the signal having the low power radio frequency carrier signal. The measurement data set may include a frequency measurement and a modulation measurement. The customer premises device may be an amplifier, a filter or a cable box (without the DOCSIS technology). The DOCSIS device may be one of a DOCSIS modem or a DOCSIS cable box at the customer site. The customer premises device may be configured to be connected to a head end over the cable network. The DOCISIS device may be configured to identify the customer premises device based on the frequency measurement and the modulation measurement by comparing the frequency measurement to a prestored frequency data and by comparing the modulation measurement to a prestored modulation data. The prestored frequency data and prestored modulation data correlate to a plurality of types of the customer premises device.

In a second example embodiment of the system for identifying a device at a customer site, the system may include a customer premises device that may be connected to a cable network. The customer premises device may be configured to generate a low power carrier signal having a predetermined frequency that correlates to the customer premises device. The customer premises device may inject the low power carrier signal into a signal to be received by a DOCSIS device that may be configured to generate a measurement data set from the signal having the low power carrier signal. In this embodiment, the customer premises device may be an amplifier, a filter or a cable box. The measurement data set may include a frequency measurement that correlates to the type of customer premises device such that the type of the customer premises device may be identified from the frequency measurement in the measurement data set. When a modulation measurement is taken together with the frequency measurement, the DOCSIS device compares the modulation measurement to a prestored modulation data. The prestored modulation data (and the prestored frequency data) correlate to a plurality of types of the customer premises device.

In this second example embodiment, the carrier signal may also have a predetermined modulation that correlates to a type of customer premises device. It is understood that the predetermined modulation makes it possible to differentiate between a plurality of customer premises devices that operate within a predetermined (or the same) frequency range. Accordingly, the DOCISIS device may be configured to identify the customer premises device based on the frequency measurement by comparing the frequency measurement to a prestored frequency data. The prestored frequency data correlates to a plurality of types of the customer premises device. In this example embodiment, the DOCSIS device may be a DOCSIS modem, a DOCSIS cable box at the customer site, or another DOCSIS device. Also, the customer premises device may be an amplifier, a filter or a cable box (without the DOCSIS technology). In this example embodiment, the customer premises device may be disposed at a customer site and the carrier signal may be a low power radio frequency signal.

In a third example embodiment, a system for identifying a device may include a device that is connected to a network. The device may be configured to generate a carrier signal having a predetermined frequency that correlates to the device. The device may be configured to inject the carrier signal into a signal to be received by a DOCSIS device connected to the network such that the DOCSIS device may be configured to generate a measurement data set from the signal having the carrier signal. The measurement data set may include a frequency measurement that correlates to the device such that the device may be identified from the frequency measurement in the measurement data set. Accordingly, the DOCISIS device may be configured to identify the customer premises device based on the frequency measurement by comparing the frequency measurement to a prestored frequency data. The prestored frequency data correlates to a plurality of types of the customer premises device.

In this third example embodiment, the device may be a customer premises device. Also, in this embodiment, the carrier signal may be a low power radio frequency carrier signal. Also, the measurement data may be generated from the frequency measurement alone, or from the frequency measurement and the modulation measurement. In this embodiment, the device may be an amplifier, a filter or a cable box (not having DOCSIS technology). When the modulation measurement is taken, the DOCSIS device compares the modulation measurement to a prestored modulation data. The prestored modulation data (and the prestored frequency data) correlate to a plurality of types of the customer premises device.

With respect to the three aforementioned example embodiments, the head end may be disposed in a head end facility. Also, the low power radio frequency carrier signal may be configured to be modulated to differentiate between a plurality of customer premises devices that operate within a predetermined frequency range. It is also understood that the low power radio frequency carrier signal may fall within a frequency range of approximately 54 mHz to 1002 mHz. In yet another example, the low power radio frequency carrier signal may alternatively fall within a frequency range of approximately 5 mHz to 42 mHz.

### BRIEF DESCRIPTION OF THE DRAWINGS

FIG. 1 illustrates a block diagram representation of various embodiments of the system for identifying a device.

FIG. 2 illustrates an example amplifier disposed at a subscriber site wherein the amplifier includes a low-cost circuit having an oscillator.

FIG. 3 is a flow chart that illustrates a first example method of identifying CPE equipment at a subscriber site from a head end.

FIG. 4 is a flow chart that illustrates a second example method of identifying a device in a network.

FIG. 5 illustrates a block diagram representation of various embodiments of the cable television (CATV) system which includes a head end and subscriber sites.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

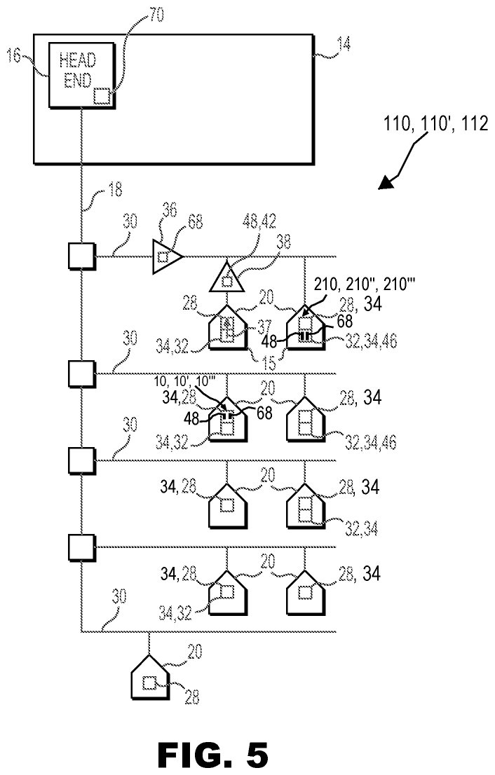

With reference to FIG. 5, there is depicted a block diagram representation of a cable television (CATV) network, generally designated 112. The CATV network 112 may be a bi-directional television signal and data communication system. It should initially be understood that the CATV network 112 is only exemplary of a bi-directional communication system environment/application in which embodiments of the present disclosure may be utilized.

The CATV network system 112 includes a cable head end facility 16 at which a head end 16 of the CATV network system 112 is located. A coaxial cable network 18 of coaxial cable or medium typically extends from the head end 16 throughout the area served by the CATV network system 112, although connections other than coaxial cable may be utilized. Subscribers 20 are connected to the coaxial cable network 18 at multiple points along its run. Interspersed throughout the run of the coaxial cable network 18 are various CATV elements/devices as are known in the art, such as amplifiers 32 and other customer premises equipment, that are part of the CATV network system 112. Various connectors or couplers as are known in the art are used throughout the CATV network system 112, but are not explicitly shown.

It is understood that the CATV network system 112 may include fiber optic cable, coax, or hybrid fiber-coax, in addition to or in place of the coaxial cable network 18. Typically, the fiber optic cable would extend from the head end 16 to a distribution point or fiber node. Coaxial cable then connects the subscribers 20 to the distribution point or fiber node. The CATV network system 112 is thus operable to provide single direction communication (transmission) and/or two-way or bi-directional communication (transmission and reception) of television and/or data signals (a band or bandwidth of signals/channels/information) between the subscribers 20 and the head end 16. It should be appreciated that the CATV network system 112 may utilize communication/signal paths between the head end 16 and the subscribers 20 other than those shown and/or described herein.

CATV networks 112 may use an infrastructure of interconnected coaxial cables, signal splitters and combiners, repeating amplifiers, filters, trunk lines, cable taps, drop lines and other signal-conducting devices to supply and distribute high frequency “downstream” CATV signals from a main signal distribution facility, known as a “head end,” to the premises (homes and offices) of subscribers to the CATV services. The downstream CATV signals transfer multimedia content to subscriber equipment, such as television sets, telephone sets and computers. In addition, most CATV networks also transmit “upstream” CATV signals from the subscriber equipment back to the head end of the CATV network. For example, the subscriber may use a set top box to select programs for display on a television set. As another example, two-way communication is essential when using a personal computer connected through the CATV infrastructure to the internet. As a further example, Voice over Internet Protocol (VoIP) telephone sets use the CATV infrastructure and the internet as the communication medium for transmitting two-way telephone conversations.

To permit simultaneous communication of upstream and downstream CATV signals and the interoperability of the subscriber equipment and the equipment associated with the CATV network infrastructure outside of subscriber premises, the downstream and upstream CATV signals are confined to two different frequency bands. In some embodiments, the downstream CATV signal frequency band may be within the frequency range of 54-1002 megahertz (MHz) and the upstream CATV signal frequency band may be within the frequency range of 5-42 MHz in most CATV networks. The entire CATV signal frequency band may therefore be with a 5-1002 MHz frequency band. The upstream CATV signal frequency band is different than the downstream CATV signal frequency band, where ‘different than’ means the frequency ranges do not overlap.

The head end 16 receives a plurality of television signals, such as from satellite receivers (not shown) for satellite transmissions and various antennas (not shown) for terrestrial transmissions, all of which are typically located at the head end facility 16. The head end facility 16 converts the plurality of television signals from the various sources to appropriate frequencies for transmission over the coaxial cable network 18 to the subscribers 20 or subscriber sites 20. As an example, the CATV network system 112 might be designed to handle forty programming channels, each of which has a unique frequency or frequency range within a particular frequency band carrying audio and video information. Frequencies used for the different channels may be adjacent to each other and spaced from each other by a set amount, i.e. typically 6 MHz.

The television signals transmitted by the head end 16 generally consist of either analog, digital, or a combination of analog and digital audio and video signals. In the case of analog television signals, the analog audio and video signals are typically in the NTSC format, but may be in any format such as are known in the art. In the case of digital television signals, the digital audio and video bitstreams are made to modulate a carrier 68 (carrier) that is upconverted for transmission over the coaxial cable network 10. This may be accomplished by applying a modulation scheme representing the audio and video bitstreams onto a radio frequency (RF) carrier. The audio and video television bitstreams are assembled or encoded utilizing a digital codec (coder/decoder) protocol such as MPEG or the like. Modulation schemes may be those as are known and/or used in the art, for example, quadrature amplitude modulation (QAM), quadrature/quaternary phase shift keying (QPSK), or vestigal sideband (VSB). Other types of digital modulation schemes may also be used as well as variations of the above-mentioned digital modulation schemes (e.g. 16-QAM, 32-QAM, 64-QAM, 256-QAM, 4-VSB, and 8-VSB). As well, different digital modulation schemes may be used for different channels of the CATV network system 112 depending on the type of data being transmitted.

Additionally, the head end 16 is operable to provide and/or support bi-directional data communications with the subscribers 20 via what is known as a cable box 28. Subscribers' premises 20 may include offices, homes, apartments, or other spaces at which network content is desired. In the illustrative embodiment, the carriers are combined for distribution downstream to subscribers over the forward path. Signals going upstream from subscribers' premises are routed in the return path.

The head end 16 may be connected to the cable boxes 28 and other customer premises equipment via a plurality of data lines 30 such as, for example, coaxial cable and/or optical fiber that transport downstream cable network signals 36 and upstream network signals 38. In some embodiments, the cable network signals are transported as radio frequency (RF) signals. The signals may also be transported in hybrid systems including optical transmission portions in which the RF signals are converted to light for fiber optic transmission over some portions of the signal path 30 and as RF signals over other portions of the signal path 30. The head end 16 may also communicate with the other components of the CATV network system 112 via the Internet (not shown). Transmissions from the subscriber sites 20 to the head end 16 are referred to as “upstream” transmissions or signals 38. The head end 16 is also configured to send signals 36 “downstream” to the cable boxes 28 by processing the signals the head end 16 receives via the Internet 18 and then transmitting downstream signals 36 to the cable boxes 28.

The CATV network system 112 may include any number of “upstream” and “downstream” channels and carriers within each channel to carry data over the data lines 18 between the head end 16 and the cable boxes 28 on the system 10. As is conventional, the head end 16 receives a plurality of television signals, such as from satellite receivers (not shown) for satellite transmissions and various antennas (not shown) for terrestrial transmissions, all of which are typically located at the head end facility 16. Additionally, the head end 16 is operable to provide and/or support bi-directional data communications with the subscribers 20 via a smart cable box 28.

The head end facility 16 converts the plurality of television signals from the various sources to appropriate frequencies for transmission over the coaxial cable network 18 to the subscribers 20. As an example, the cable system 10 might be designed to handle forty programming channels, each of which has a unique frequency or frequency range within a particular frequency band carrying audio and video information. Frequencies may be adjacent to each other and spaced from each other by a set amount, i.e. typically 6 MHz.

However, for example, while most cable providers today use a 5-1002 MHz RF spectrum, some cable providers are considering an expansion to 5-1218 MHz in order to add more data. This expansion of the frequency band which will exceed 1002 MhZ to add more data transmission ability could present issues for older amplifiers and other older CPE equipment which are configured to handle at most a signal at 1002 MHz. Therefore, it is desirable for cable providers to quickly and easily identify the existence, type and location of CPE equipment on a remote basis so that outdated or older CPE equipment could be easily and quickly identified (from a remote location such as the head end facility) for replacement or to assist the customer/subscriber with troubleshooting issues. Therefore, as issues arise at subscriber locations 20, it is helpful for providers to know what equipment is actually located at the subscriber location 20. Moreover, as providers plan to roll out updates, the provider could also replace older CPE equipment (amplifiers, signal conditioning filters, etc) before the upgrade or data expansion to prevent or reduce the number of issues at the subscriber premises.

Maintaining an accurate list of equipment at the various subscriber sites may be challenging. For example, equipment can often be shared between relatives and neighbors (after installation by the cable operator). In yet another example, the cable technician may incorrectly document or maintain the inventory list at the various subscriber sites. Accordingly, there is a need to accurately and quickly identify the type of equipment implemented at a subscriber's or customer site. Therefore, the present disclosure relates to a system and method for identifying CPE equipment from a remote location.

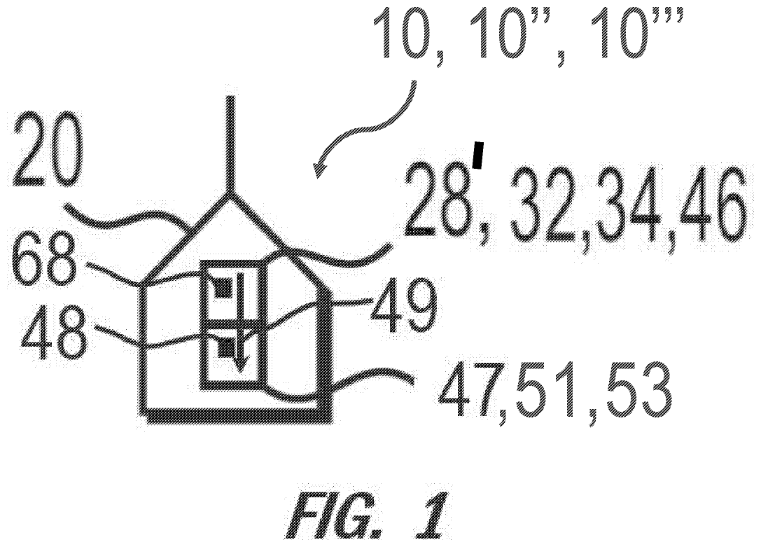

Referring to FIG. 1, a first example embodiment of the system 10 for identifying a customer premises device 34 at a customer site 20 is shown. The customer premises device (or subscriber device) 34 may be setup by the manufacturer (or adjusted later) such that the device 34 is configured to automatically insert or inject the carrier as described below.

As shown in FIG. 1, a first example embodiment of the system 10 may include a customer premises device 34 and a DOCSIS device 47. The customer premises device 34 may be disposed at a customer site 20 and may be configured to be connected to a cable network 112 (see FIG. 5). The DOCSIS device 47 may also be connected to the cable network 112 (see FIG. 5). The customer premises device 34 may be configured to generate a low power radio frequency carrier signal 68 having a predetermined frequency and a predetermined modulation that correlates to a type of customer premises device 34. The customer premises device 34 may be an amplifier 32, a filter 46 or a cable box 28′ (without the DOCSIS technology). The customer premises device 34 may be configured to inject the low power radio frequency carrier signal 68 into a signal 49 wherein the signal 49 is received by the DOCSIS device 47.

In this embodiment, DOCSIS device 47 may be configured to generate a measurement data set 48 from the signal 49 having the low power radio frequency carrier signal 68. The measurement data set 48 may include a frequency measurement and a modulation measurement. The DOCSIS device 47 may be one of a DOCSIS modem 51, a DOCSIS cable box or another DOCSIS device at the customer site 20. The customer premises device 34 may be configured to be connected to a head end 16 over the cable network 112 (see FIG. 5). The DOCSIS device 47 may be configured to identify the customer premises device 34 based on the predetermined frequency and the predetermined modulation as later described herein.

The DOCISIS device 47 may be configured to identify the customer premises device based on the frequency measurement and the modulation measurement by comparing the frequency measurement to a prestored frequency data and by comparing the modulation measurement to a prestored modulation data. The prestored frequency data and prestored modulation data correlate to various types of the customer premises devices 34. In this example, it is understood that the DOCSIS device 47 of FIG. 1 may further implement a lookup table (see element 70 shown in FIG. 5) wherein lookup table 70 is disposed in the DOCSIS device and stores the prestored frequency data and the prestored modulation data together with the various types of the customer premises device 34.

In a second example embodiment of the system for identifying a device 34 at a customer site 20, the system 10″ may include a customer premises device 34 that may be connected to a cable network 112 (see FIG. 5). The customer premises device 34 may be configured to generate a low power carrier signal 68 having a predetermined frequency that correlates to the customer premises device 34. The customer premises device 34 may inject the low power carrier signal 68 into a signal 49 to be received by a DOCSIS device 47. The DOCSIS device 47 may be configured to generate a measurement data set 48 from the signal 49 having the low power carrier signal 68. In this embodiment, the customer premises device 34 may be an amplifier 32, a filter 46 or a cable box 28′ (not having the DOCSIS technology). The measurement data set 48 may include a frequency measurement that correlates to the type of customer premises device 34 such that the type of the customer premises device 34 may be identified from the frequency measurement in the measurement data set 48. The identification of the customer premises device 34 from the frequency measurement in the measurement data set 48 could occur manually or automatically by the DOCSIS device. The DOCSIS device 47 of FIG. 1 may further implement a lookup table (see element 70 shown in FIG. 5).

Accordingly, the DOCISIS device 47 may be configured to identify the customer premises device based on the frequency measurement by comparing the frequency measurement of the measurement data set 48 to a prestored frequency data. The prestored frequency data correlates to various types of the customer premises devices 34. In this example, it is understood that the DOCSIS device 47 of FIG. 1 may further implement a lookup table (see element 70 shown in FIG. 5) wherein lookup table 70 is disposed in the DOCSIS device 47 and stores the prestored frequency data and the prestored modulation data together with the various types of the customer premises device 34 such that the data correlates to specific types of devices 34.

In this second example embodiment system 10″ (see FIG. 1), the carrier signal 68 may also have a predetermined modulation that correlates to a type of customer premises device 34. It is understood that the predetermined modulation makes it possible to differentiate between a plurality of customer premises devices 34 that operate within a predetermined (or the same) frequency or frequency range as later described herein. Accordingly, the DOCSIS device 47 may be configured to identify the customer premises device 34 based on the predetermined modulation at the predetermined frequency. The DOCSIS device 47 may compare the frequency measurement and the modulation measurement of the measurement data set 48 to a prestored frequency data and a prestored modulation data disposed in a lookup table 70 (see FIG. 5) in the DOCSIS device 47. In this example embodiment, the DOCSIS device 47 may be a DOCSIS modem 51, a DOCSIS cable box 53 or another DOCSIS device at the customer site 20. Also, the customer premises device 34 may be an amplifier 32, a filter 46 or a cable box 28′ (without the DOCSIS technology). In this example embodiment, the customer premises device 34 may be disposed at a customer site 20 and the carrier signal 68 may be a low power radio frequency signal.

In a third example embodiment, a system 10′″ (FIG. 1) for identifying a device may include a device 34 that is connected to a network 112. The device 34 may be configured to generate a carrier signal 68 having a predetermined frequency that correlates to the device 34. The device 34 may be configured to inject the carrier signal 68 into a signal 49 to be received by a DOCSIS device 47 that is connected to the network. The DOCSIS device 47 may be configured to generate a measurement data set 48 from the signal 49 having the carrier signal 68. The measurement data set 48 may include a frequency measurement that correlates to the device 34 such that the device 34 may be identified from the frequency measurement in the measurement data set 48. The measurement data set 48 may be interpreted by a person, software and/or a machine (such as but not limited to the DOCSIS device 47) to identify the type of device 34. The DOCSIS device 47 of FIG. 1 may further implement a lookup table (see element 70 shown in FIG. 5).

Accordingly, the DOCISIS device 47 may be configured to identify the customer premises device based on the frequency measurement of the measurement data set 48 by comparing the frequency measurement to a prestored frequency data disposed in a lookup table 70. The prestored frequency data correlates to various types of the customer premises devices 34. In this example, it is understood that the DOCSIS device 47 of FIG. 1 may further implement a lookup table (see element 70 shown in FIG. 5) wherein lookup table 70 is disposed in the DOCSIS device and stores the prestored frequency data and the prestored modulation data together with the various types of the customer premises device 34.

In this third example embodiment system 10′″ (see FIG. 1), the carrier signal 68 may also have a predetermined modulation that correlates to a type of customer premises device 34. It is understood that the predetermined modulation makes it possible to differentiate between a plurality of customer premises devices 34 that operate within a predetermined (or the same) frequency or frequency range as later described herein. Accordingly, the DOCSIS device 47 may be configured to identify the customer premises device 34 based on the predetermined modulation at the predetermined frequency. The DOCSIS device 47 may compare the frequency measurement and the modulation measurement of the measurement data set 48 to a prestored frequency data and a prestored modulation data disposed in a lookup table 70 (see FIG. 5) in the DOCSIS device 47 to identify the type of device 34.

In this third example embodiment of the system 10′″, the device 34 may be a customer premises device 34 in the form of an amplifier 32, a filter 46 or a cable box 28′ (not having DOCSIS technology) or other device located at a customer site 20. Also, in this embodiment, the carrier signal 68 may be a low power radio frequency carrier signal 68. Also, the measurement data set 48 may be generated from the frequency measurement alone, or both the frequency measurement and the modulation measurement as previously described and later described herein.

With respect to the three aforementioned example embodiments, the head end 16 may be disposed in a head end facility 14. Also, the low power radio frequency carrier signal 68 may be configured to be modulated to differentiate between a plurality of customer premises devices 34 that operate within a predetermined (or the same) frequency range measurement as previously described and later described herein. It is also understood that the low power radio frequency carrier signal 68 may fall within a frequency range of approximately 54 mHz to 1002 mHz. In yet another example, the low power radio frequency carrier signal 68 may alternatively fall within a frequency range of approximately 5 mHz to 42 mHz.

With respect to all embodiments of the present disclosure, it is understood that radio frequency (RF) energy (as well as “blank spaces”) can exist anywhere in the signal architecture. Therefore, an identifying carrier 68 can be injected into a “blank space” in a signal 49 (by the customer premises device 34) and the presence or absence of the identifying carrier 68 could be picked up by a DOCSIS device 47. Therefore, in one non-limiting example, if a carrier 68 exists at 52.5 MHz, then measurement data 48 will show that an amplifier 32 is present at the customer site 20. It may be possible to use other frequency slots as markers for other types of devices 34. For example, a carrier 68 existing or becoming evident to a user/program/,machine at 52.5 MHz, could then be interpreted to mean that a “5-port” amplifier exists at the customer site 20. Alternatively, a carrier 68 existing or becoming evident to a user/program/machine at 53.5 MHz could be interpreted to mean that a “9-port” amp marker at the customer site 20.

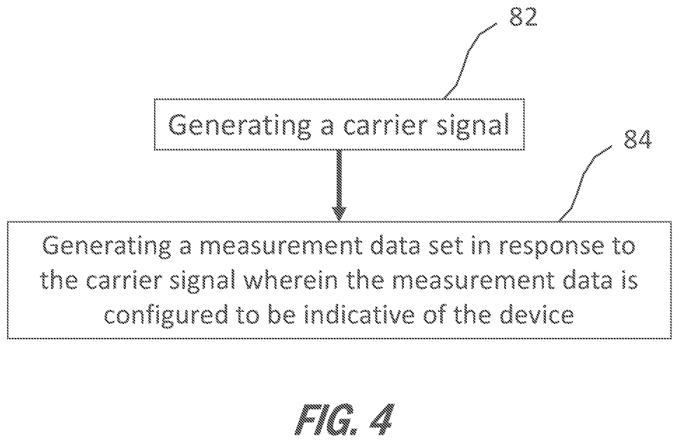

Referring to FIG. 5, a fourth example embodiment of the system 210 for identifying a customer premises device 34 at a customer site 20 may include a customer premises device (or subscriber device) 34 disposed at a customer site 20. In some embodiments, the customer premises device 34 may be configured to be connected to a cable network 112. As shown in FIG. 5, the customer premises device 34 may be configured to generate a low power radio frequency carrier signal (or carrier) (shown as element 68 disposed in element 34 in FIG. 5; see also step 82 in FIG. 4). The customer premises device 34 may generate a measurement data (or data set) 48 in response to the low power radio frequency carrier signal 68 (shown as element 48 disposed in element 34; (see also step 84 in FIG. 4)). As shown in FIG. 5, the customer premises device 34 may be any one a variety of active devices 34 implemented at a customer site 20 such as an amplifier 32, a filter 46, a cable box 28 or the like. If the customer premises device 34 is not a cable box 28, the customer premises device 34 that is subject to identification may be upstream or downstream of the cable box 28. In some embodiments, the cable box 28 may be a smart cable box that implements DOCSIS technology. It is understood that the measurement data (or data set) 48 may further include a frequency measurement and/or a modulation measurement generated in response to the carrier signal. In some embodiments, the customer premises device 34 may be connected to a head end 16 over the cable network 112 via data lines 30.

With respect to the frequency measurement and the modulation measurement, it is understood that the various systems for identifying a device 34 of the present disclosure are configured to identify the type of device 34 (amplifier 32 vs. filter 46 vs. cable box 28, etc) and are also configured to distinguish between different versions of the same device 34 (Amplifier A vs Amplifier B, Filter A vs. Filter B, etc.). In one non-limiting example, the system 210′ of the present disclosure may be able to determine whether an amplifier 32, or a filter 46, or a cable box 28 is disposed at a customer site 20 by measuring the frequency of the carrier signal 68 with the understanding that the frequency of the carrier signal 68 may be indicative of the type of device 34 (amplifier 32 vs. filter 46 vs. cable box 28, etc). With respect to differentiating between two or more different versions of the same type of device 34 (ex: two or more amplifiers 32; two or more different types of filters 46; etc.) which are disposed at a customer site 20, the low power radio frequency carrier signal 68 may be modulated to differentiate between this plurality of customer premises devices 34 that operate within a predetermined frequency range. For example, it may be known that all amplifiers 32 operate within a predetermined frequency range and therefore, the carrier signal 68 may be modulated such that the carrier signal 68 may blink once to identify Amplifier A or the carrier signal 68 may blink twice to identify Amplifier B—however the modulated carrier signal 68 may be in a predetermined frequency range which corresponds specifically to amplifiers 32. In yet another example, it may be known that all filters 46 operate within a predetermined frequency range (different from all amplifiers 32) and therefore, the carrier signal 68 may be modulated such that the carrier signal 68 may blink once to identify Filter A or the carrier signal 68 may blink twice to identify Filter B—however the modulated carrier signal 68 may be in a predetermined frequency range which corresponds specifically to filters 46 (wherein that predetermined frequency range for filters 46 is distinct from the predetermined frequency range for amplifiers 32). It is also understood that in all embodiments, DOCSIS (Data Over Cable Service Interface Specification) technology may be implemented in the cable box 28 and/or the head end 16 may be disposed at a head end facility 14.

Moreover, it is understood that the measurement data 48 of certain systems of the present disclosure may be configured to identify the customer premises device 34 by comparing the measurement data 48 generated by the device 34 (see FIG. 5) or the DOCSIS device 47 (see FIG. 1) from the carrier signal 68 to data stored in a lookup table 70 (which could be located anywhere) wherein the measurement data 48 may be correlated to specific types of customer premises devices 34 according to certain data such as, but not limited to frequency. The comparing of the measurement data to the data stored in the lookup table 70 could be performed in a DOCSIS device 47, such as a cable box 51, a DOCSIS modem 53 connected to the network 112, or at the head end 16.

A fifth example embodiment of the system 210″ for identifying a customer premises device 34 at a customer site 20 is also shown in FIG. 5. The system 210″ includes a customer premises device 34 configured to be connected to a cable network 112, wherein the customer premises device 34 is configured to generate a carrier signal 68 (shown as element 68 disposed in element 34 in FIG. 5; see also step 82 in FIG. 4). As shown in FIG. 5, the customer premises device 34 may also be configured to generate a measurement data 48 in response to the carrier signal 68 (shown as element 48 disposed in element 34 in FIG. 5; see also step 84 in FIG. 4). The customer premises device 34 may be one of an amplifier 32, a filter 46 or a cable box 28 (or other active customer premises equipment). The measurement data 48 may include a frequency measurement and/or a modulation measurement. The measurement data 48 may be configured to identify the customer premises device 34. In this example embodiment, the customer premises device 34 may be disposed at a customer site 20. Also, the carrier signal 68 may be a low power radio frequency (RF) signal 68. The customer premises device 34 may also be connected to a head end 16 over the cable network 112. In this fifth example embodiment, the carrier signal 68 may be modulated to a predetermined modulation to differentiate between a plurality of customer premises devices 34 that operate within a predetermined frequency range.

A sixth example embodiment of the system 210′″ for identifying a customer premises device 34 at a customer site 20 may include a device 34 disposed at the customer site 20 wherein the device 34 is connected to a network 112. The device 34 may be configured to generate a carrier signal 68 (shown as element 68 disposed in element 34 in FIG. 5; see also step 82 in FIG. 4) and to generate a measurement data set 48 in response to the carrier signal 68 (shown as element 48 disposed in element 34 in FIG. 5; see also step 84 in FIG. 4). The measurement data set 48 may be indicative of the device 34 as previously described. In this sixth example embodiment, the device 34 may be a customer premises device 34 and the carrier signal 68 may be a low power radio frequency carrier signal 68. The measurement data 48 may include a frequency measurement and/or a modulation measurement. The device 34 may be one of an amplifier 32, a filter 46, a cable box 28, or any other network device disposed at the subscriber site 20. In this example embodiment, the device 34 may be connected to a head end 16 over the cable network 112. As previously described, the carrier signal 68 may be modulated to differentiate between a plurality of different customer premises devices 34 that operate within a predetermined frequency range.

With respect to the aforementioned embodiments of the system 210, 210″, 210′″ for identifying a device 34 of the present disclosure, it is understood that the carrier signal 68 may fall within a higher frequency range of approximately 54 mHz to 1002 mHz or within a lower frequency range of approximately 5 mHz to 42 mHz.

Referring back to FIG. 5, a seventh example system 110 for identifying an accessory subscriber device 34 at a subscriber site 20 having a head end 16 having a lookup table 70, a subscriber site 20 at a remote location 15, and a smart cable box 28 disposed at the subscriber site 20 wherein the head end 16 is configured to transmit a downstream signal 36 from the head end 16 to the smart cable box 28. The subscriber site 20 may be configured to be in electronic communication with the head end 16 via a data line 30. The smart cable box 28 is configured to measure the downstream signal 36 from the head end 16 and to generate a measurement data set 48. The smart cable box 28 may also be configured to transmit the measurement data set 48 to the head end 16. The head end 16 may be configured to compare the measurement data set 48 against the lookup table 70 to identify the existence of an accessory subscriber device 34 at the subscriber site 20. The subscriber device 34 in this embodiment may be one of any variety of subscriber (CPE) devices 34 which include but are not limited to an amplifier 32 or a filter 46, the cable box 28, etc.

This example system of the present disclosure may include a low power RF carrier 68 injected in the downstream signal 36. The smart cable box 28 may then be configured to measure the low power carrier 68 from the head end 16 and generate a carrier measurement data set 42 and to transmit the carrier measurement data set 42 to the head end 16. The head end 16 may be configured to compare the carrier measurement data set 42 against the lookup table 70 to identify the existence of an accessory subscriber device 34 at the subscriber site 20.

In an example embodiment the present disclosure (FIG. 5), an alternative network system 110′ may include a head end 16 having a lookup table 70, a subscriber site 20 in electronic communication with the head end 16 via a data line 30, and a smart cable box 28 disposed at the subscriber site 20. (See FIG. 5). The head end 16 may be configured to transmit a downstream signal 36 having a low power carrier 68 from the head end 16 to the smart cable box 28. The smart cable box 28 may be configured to measure the low power carrier 68 from the head end 16 and to generate a carrier measurement data set 42. The smart cable box 28 may be configured to transmit the carrier measurement data set 42 to the head end 16. The head end 16 may be configured to compare the carrier measurement data set 42 against the lookup table 70 to identify the existence of an accessory subscriber device 34 at the subscriber site 20, such as the smart cable box 28. The smart cable box 28 may be configured to measure at least one of a frequency or a modulation of the low power carrier 68. The carrier measurement data set 42 includes at least one of a frequency measurement or a modulation measurement. The subscriber device 34 in this embodiment may be one of any variety of subscriber (CPE) devices 34 which include but are not limited to an amplifier 32, a filter 46 or the cable box 28.

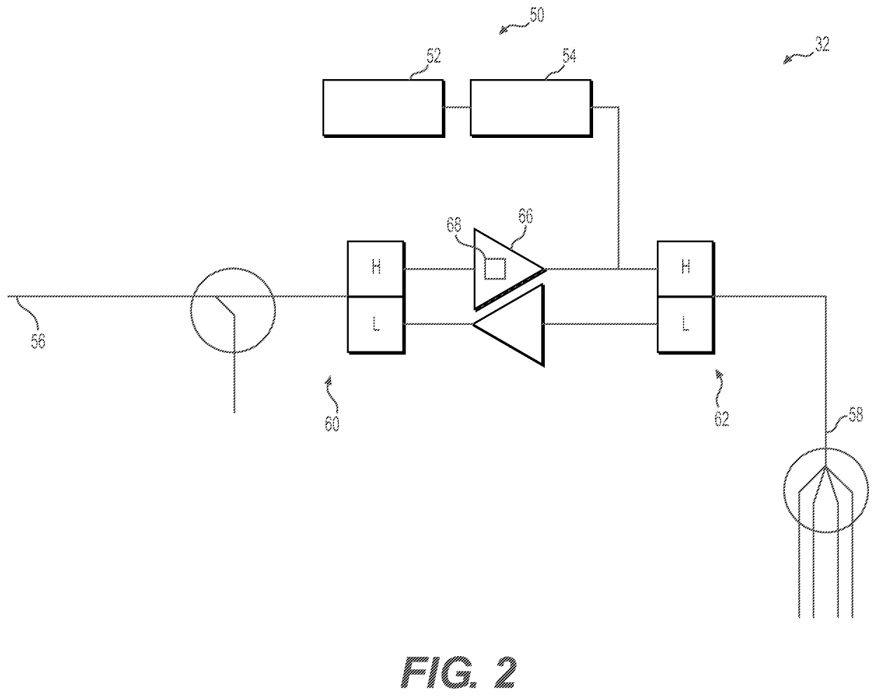

The method of the present disclosure particularly relates to a method of determining the existence of CPE equipment proximate to the subscriber's site (ex: amplifier 32 at a subscriber's site 20) from a remote location (such as head end facility 16), as well as determining the type of CPE equipment (ex: amplifier 32 shown in FIG. 2) used at a subscriber's site 20 from a remote location such as a head end facility 16.

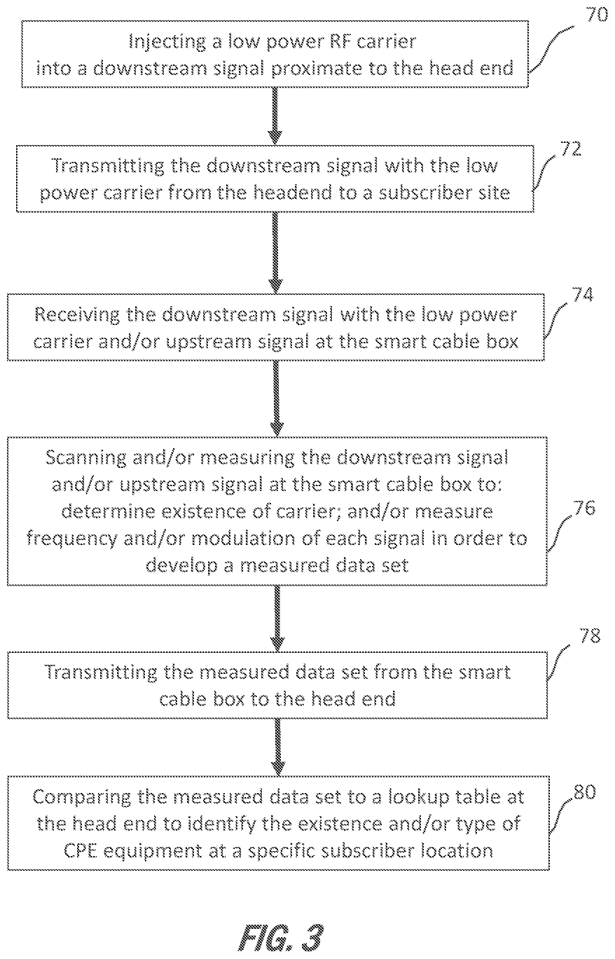

Referring back to FIG. 3, an example method that may be implemented by the network systems 110, 110′ (FIG. 5) of the present disclosure is illustrated. The method may include: (1) injecting a low power RF carrier into a downstream signal proximate to the head end (step 70); (2) Transmitting the downstream signal with the low power RF carrier from the headend to a subscriber site (step 72); (3) Receiving the downstream signal with optional low power RF carrier and/or receiving an upstream signal at the smart cable box (step 74); (4) To develop a carrier measurement data set, scanning and/or measuring the downstream signal and/or upstream signal at the smart cable box to: (a) determine existence of carrier; and/or (b) measure frequency and/or modulation of each upstream signal and downstream signal (Step 76); (5) Transmitting the carrier measurement data set 48 from the smart cable box to the head end (step 78) or to another DOCSIS device, such as a DOCSIS modem connected to the network; and (6) Comparing the carrier 68 measurement data set to a lookup table at the head end (or at the other DOCSIS device) to identify the existence and/or type of CPE equipment at a specific subscriber location (step 80).

In one non-limiting example, a cable provider may seek to determine whether a subscriber site 20 has an amplifier 32. As shown in FIGS. 2 and 5, each subscriber site 20 may or may not have an amplifier 32. The amplifier 32 may have a low-cost circuit 50 which includes an oscillator 52 (and optionally a low pass filter 54 as well). The aforementioned amplifier 32 may be in communication with the head end 16 and the subscriber's cable box 28. The aforementioned example method may be implemented to determine existence of an amplifier 32 at a subscriber's site 20 from a remote location (such as head end facility 16) as well as determining the type of amplifier 32 used at a subscriber's site 20 from a remote location.

Referring again to FIG. 2, an example amplifier 32 of the present disclosure includes an input 56, an output 58, an input diplex filter 60 and an output diplex filter 62 disposed between the input 56 and the output 58. As shown in FIG. 2, the amplifier 32 also includes an oscillator 52. The low pass filter 54 shown in FIG. 2 may be provided with the amplifier oscillator 52 within the amplifier 32. The optional low pass filter 54 is configured to prevent any harmonics which may come out of the oscillator 52. As shown, the oscillator 52 and the optional low pass filter 54 are in communication with the downstream signal 66. The optional low pass filter 54 prevents/reduces harmonics that could come from the oscillator 52.

A CATV provider may inject a lower power carrier 68 (low power RF carrier 68) into the downstream signal such that the smart cable box 28 could be configured to detect the lower power carrier 68 (low power RF carrier 68). The detection of the lower power carrier 68 (low power RF carrier 68) at the smart cable box would, in itself, be indicative that an amplifier 32 or other CPE equipment exists at the subscriber's site 20. Thus, in this example, the downstream signal 36 which is fed to a subscriber's site 20 may include a lower power carrier 68 (low power RF carrier 68) wherein the low power carrier or carrier 68 is at a predetermined frequency location. In the event that the subscriber's site 20 implements an amplifier 32, the DOCSIS (Data Over Cable Service Interface Specification) technology in the smart cable box 28 may be configured to measure downstream signal(s) (and/or upstream signal(s)) to determine existence and/or type of amplifier 32 (or other CPE equipment). It is understood that the cable box 28 would implement DOCSIS technology.

It is also understood that a failure to detect the lower power carrier 68 (low power RF carrier 68) may also be indicative that the amplifier 32 (or other specific CPE equipment such as a filter) is not implemented at the subscriber's site 20. It is understood that the DOCSIS technology may disposed in the subscriber's cable box 28 and/or modem such that the smart cable box 28 may be configured to a full spectrum capture of the upstream signals 38 and/or downstream signals 36 wherein: (1) the incoming low power RF carrier may be scanned; and/or (2) the upstream and/or downstream signals 36, 38 may be measured to provide a resulting measurement data set 48 (optionally in the form of a pictorial representation of the spectrum, modulation, frequencies and power levels). It is understood that the smart cable box 28 may transmit the measurement data set 48 back to the cable provider at the head end 16.

The smart cable box 28 having a DOCSIS modem is configured to determine the frequencies that are being delivered to the smart cable box 28 wherein the smart cable box 28 (having a DOCSIS modem) can measure signal frequencies and modulations. Thus, the DOCSIS modem has a built-in diagnostic tool. Signals 36,38 may be transmitted with varying modulations in a specific frequency for specific types of CPE equipment 34 (ex: modem; amplifier; etc.). It is understood that MOCA technology enables signals to move upstream and downstream within a single subscriber site 20 and therefore, the DOCSIS modem in the smart cable box 28 may also be configured to measure upstream signals 38 which are reflected back to the DOCSIS modem from other (accessory) CPE equipment 34 that is disposed downstream of the DOCSIS modem.

Therefore, as indicated, the smart cable box 28 may be configured to provide data 42, 48 which represents the spectrum, modulation, frequencies, power levels and signals detected by the smart cable box. Such data may, but is not limited to, a pictorial representation of the spectrum, modulation, frequency, and power levels for the various signals may be provided by the DOCSIS technology in the cable box 28. The measurement data set 42, 48 may be transmitted upstream to the head end 16 and matched against a data table 70 (see FIG. 5) to determine the type of CPE equipment (ex: amplifier 32) which is implemented at a subscriber's remote location 20. For example, the data table 70 may identify various types of CPE equipment and the corresponding modulations/frequencies (for each type of CPE device) where: (1) the measurements of the signal modulations/frequencies and/or (2) the existence of the carrier (low RF carrier 68) will be visible/apparent as part of the DOCSIS feedback data.

In an example table, Amplifier A and Amplifier B may each be associated with data where the carrier is visible/apparent at X frequency. The smart cable box may be configured to measure the modulation of each signal to determine whether Amplifier A or Amplifier B is located at a subscriber/customer site 20. In one example, the signal may Blink 3 times to correspond to Amplifier A whereas the signal may blink 4 times to correspond to Amplifier B. Therefore, it is understood that the cable provider may also modulate the carrier 68 in order to reveal more information about CPE equipment at the subscriber's site 20 and/or the quality of operation of the CPE equipment at the subscriber's site 20.

In yet another example, the system and method of the present disclosure may determine the existence of yet another CPE product C (ex: amplifier, filter, etc.) wherein this third CPE product C may be associated with feedback data where the carrier is visible/apparent at Y frequency (that is distinct and does not overlap with previously identified X frequency).

Nonetheless, via the lookup table 70 (see FIG. 5) and measurement data set 42, 48 from the cable box 28, amplifiers 32 or other CPE equipment 34 located at subscriber sites 20 may be remotely identified (by the cable provider) to determine whether the CPE equipment 34 fails to meet new/higher requirements (for example, due to the implementation of an increased RF spectrum up to 1218 MHz, etc), and such example amplifiers 32 may be marked as needing replacement preferably before an upgrade or change to the network 112. Additionally, the identification of the CPE may occur at a DOCSIS modem connected to the network 112 instead of at the head end 16, and this identification could be transmitted to the headend 16 over the network 112.

Referring now to FIG. 4, an example method that may be implemented by the systems 10, 10″, 10′″ (shown in FIG. 1) and systems 210, 210″, 210′″ (shown in FIG. 5) of the present disclosure is illustrated. In step 82, a device 34 in the network, such as the set top box, amplifier or filter (or other active device connected to the network generates a carrier signal 68. In step 84, the either the device 34 (FIG. 5) or a DOCSIS device 47 (FIG. 1) then generates a measurement data set 48 from the carrier signal 68. The measurement data set 48 may be configured to be indicative of the device 34. In some embodiments, the measurement data set 48 may include data identifying the device as an amplifier 32, a filter, etc. In some embodiments, the measurement data set 48 may include data that can be utilized to identify the device, such as comparing the measurement data set to the data in a lookup table 70 as previously explained.

While example embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for identifying a customer premises device at a customer site comprising:
a customer premises device disposed at a customer site and being configured to be connected to a cable network;
a DOCSIS device connected to the cable network;
wherein the customer premises device is configured to generate a low power radio frequency carrier signal having a predetermined frequency and a predetermined modulation that correlates to a type of the customer premises device;
wherein the customer premises device is configured to inject the low power radio frequency carrier signal into a signal, the signal being received by the DOCSIS device;
wherein the DOCSIS device is configured to generate a measurement data set of the signal having the low power radio frequency carrier signal, and the measurement data set includes a frequency measurement and a modulation measurement;
wherein the customer premises device is one of an amplifier, a filter or a cable box at the customer site;
wherein the DOCSIS device is one of a DOCSIS modem or a DOCSIS cable box at the customer site;
wherein the customer premises device is configured to be connected to a head end over the cable network; and
wherein the DOCSIS device is configured to identify the customer premises device based on the predetermined frequency and the predetermined modulation by comparing the frequency measurement and the modulation measurement to a prestored frequency data and a prestored modulation data that correlates to a plurality of types of the customer premises device.

2. The system for identifying a customer premises device as defined in claim 1, wherein the head end is disposed in a head end facility.

3. The system for identifying a customer premises device as defined in claim 1, wherein the low power radio frequency carrier signal is configured to be modulated to differentiate between a plurality of customer premises devices that operate within a predetermined frequency range.

4. The system for identifying a customer premises device as defined in claim 1 wherein the low power radio frequency carrier signal falls within a frequency range of approximately 54 mHz to 1002 mHz.

5. The system for identifying a customer premises device as defined in claim 1 wherein the low power radio frequency carrier signal falls within a frequency range of approximately 5 mHz to 42 mHz.

6. A system for identifying a device at a customer site comprising:
a customer premises device being configured to be connected to a network;
wherein the customer premises device is configured to generate a low power carrier signal having a predetermined frequency that correlates to the customer premises device;
wherein the customer premises device is configured to inject the low power carrier signal into a signal to be received by a DOCSIS device connected to the network, the DOCSIS device being configured to generate a measurement data set from the signal having the low power carrier signal;
wherein the customer premises device is one of an amplifier, a filter or a cable box; and
wherein the measurement data set includes a frequency measurement that correlates to the type of customer premises device; and
wherein the DOCSIS device is configured to identify the customer premises device based on the predetermined frequency by comparing the frequency measurement to a prestored frequency data that correlates to a plurality of types of the customer premises device.

7. The system for identifying a customer premises device as defined in claim 6, wherein the carrier signal is configured to be modulated to a predetermined modulation to differentiate between a plurality of customer premises devices that operate within a predetermined frequency range.

8. The system for identifying a customer premises device as defined in claim 6, wherein the measurement data set is configured to identify the customer premises device based on the predetermined modulation at the predetermined frequency.

9. The system for identifying a customer premises device as defined in claim 6, wherein the DOCSIS device is one of a DOCSIS modem or a DOCSIS cable box at the customer site.

10. The system for identifying a customer premises device as defined in claim 6, wherein the customer premises device is one of an amplifier, a filter or a cable box.

11. The system for identifying a customer premises device as defined in claim 6 wherein the customer premises device is disposed at a customer site.

12. The system for identifying a customer premises device as defined in claim 6, wherein the carrier signal is a low power radio frequency signal.

13. The system for identifying a customer premises device as defined in claim 6, wherein the customer premises device is configured to be connected to a head end over the network.

14. The system for identifying a customer premises device as defined in claim 7, wherein the measurement data set includes a modulation measurement and wherein the DOCSIS device is configured to identify the customer premises device by comparing the modulation measurement to a prestored modulation data.

15. The system for identifying a customer premises device as defined in claim 6, wherein the carrier signal falls within a frequency range of approximately 54 mHz to 1002 mHz.

16. The system for identifying a customer premises device as defined in claim 6, wherein the carrier signal falls within a frequency range of approximately 5 mHz to 42 mHz.

17. A system for identifying a device comprising:
a device being configured to be connected to a network;
wherein the device is configured to generate a carrier signal having a predetermined frequency that correlates to the device;
wherein the device is configured to inject the carrier signal into a signal to be received by a DOCSIS device, the DOCSIS device being connected to the network and being configured to generate a frequency measurement from the signal having the carrier signal; and
wherein the DOCSIS device is configured to identify the customer premises device based on the predetermined frequency by comparing the frequency measurement to a prestored frequency data that correlates to a plurality of types of the customer premises device.

18. The system for identifying a device at a customer site as defined in claim 17 wherein the device is a customer premises device.

19. The system for identifying a device as defined in claim 17, wherein the carrier signal is a low power radio frequency carrier signal.

20. The system for identifying a device as defined in claim 17, wherein the measurement data is generated from at least one of a frequency measurement.

21. The system for identifying a device as defined in claim 17, wherein the device is one of an amplifier, a filter or a cable box.

22. The system for identifying a device as defined in claim 17, wherein the carrier signal is configured to be modulated to differentiate between a plurality of customer premises devices that operate within a predetermined frequency range.

23. The system for identifying a device as defined in claim 23, wherein the measurement data set includes a modulation measurement and wherein the DOCSIS device is configured to identify the customer premises device by comparing the modulation measurement to a prestored modulation data.

24. The system for identifying a device as defined in claim 17 wherein the carrier signal falls within a frequency range of approximately 54 mHz to 1002 mHz.

25. The system for identifying a device as defined in claim 17 wherein the carrier signal falls within a frequency range of approximately 5 mHz to 42 mHz.
